(19) United States
(12) Patent Application Publication
(10) Pub. No.: US 2016/0008192 A1
(43) Pub. Date: Jan. 14, 2016

(54) FOLDING WHEELCHAIR

(71) Applicant: César CALERO CEBRIÁN, Valencia (ES)

(72) Inventor: César CALERO CEBRIÁN, Valencia (ES)

(21) Appl. No.: 14/792,793

(22) Filed: Jul. 7, 2015

(30) Foreign Application Priority Data
Jul. 8, 2014 (ES) P201431024

(51) Int. Cl. A61G 5/08; A61G 5/10; A61G 5/02

(52) U.S. Cl. CPC A61G 5/08; A61G 5/022; A61G 5/1005; A61G 2005/0825; A61G 2005/0833

(57) ABSTRACT

Folding wheelchair for disabled people designed for recreational use, preferably to provide mobility on beach sand. This folding wheelchair is designed for active disabled people with arm mobility, and who want to be able to travel independently on sand beaches. The folding wheelchair comprises the following: three rigid wheels in a tricycle configuration, two rear wheels and a front wheel; a frame located between the two rear wheels comprising a seat with a backrest and a footrest; and two axes of the rear wheels. Additionally, the folding wheelchair comprises a single-arm chassis located on one of the sides of said wheelchair, which connects the frame with the front wheel. The rear wheels comprise propelling hand rims located between the rear wheels and the seat, and a reduction mechanism to reduce the force applied on said rear wheels.

### OBJECT OF THE INVENTION

The present invention refers to a folding wheelchair for disabled people designed for recreational use, preferably to provide mobility on beach sand.

This folding wheelchair is designed for active disabled people with arm mobility, and who want to be able to move independently on sand beaches.

This folding wheelchair is propelled using propelling hand rims just as in conventional wheelchairs and it comprises a reduction mechanism aimed at reducing the amount of force applied to overcoming the rolling resistance on surfaces such as sand.

It is of particular use in the industry that manufactures equipment for disabled people.

### ART PROBLEM TO ADDRESS AND BACKGROUND OF THE INVENTION

Up until now, disabled people needed to go to beaches fitted with wooden walkways in order to be able to approach the sea with their wheelchairs. These walkways are normally few and inefficient, forcing these people and those with them to remain within the confines of these special areas.

Moreover, it is common knowledge that when you try to transport a conventional wheelchair user on beach sand, the rear wheels dig several centimetres down and the tiny front wheels are completely buried, which makes progress almost impossible.

Therefore, nowadays there are some models of wheelchairs designed for recreational use that you can take into the water or that can be used to transport the user on sand; however, these wheelchairs are not self-propelled (by means of the strength of the user), therefore, you need another person to push the wheelchair.

Other wheelchair models are designed with self-propelling systems that, due to the small diameter and width of the wheels, have a high rolling resistance and require the application of disproportionate force, sometimes making it impossible to propel over surfaces made up of loose sand.

Moreover, the full chassis of these wheelchairs prevent the user from making comfortable and easy transfers (such as moving from one chair to another or to the ground, the bed, etc.).

Therefore, the present invention solves the problems of the state of the art mentioned previously by providing a folding wheelchair built with rigid wheels (wheels that do not have a tyre nor a tube) so disabled people are able to travel on beach sand, where the rear wheels comprise dimensions such as width and diameter that are especially designed for difficult terrains such as sand, where propelling hand rims and a reduction mechanism reduce the amount of force applied to overcoming the high rolling resistance, and where the chair also comprises a single-arm chassis located on one of the sides of the wheelchair, which allows the user to make comfortable and easy transfers.

### DESCRIPTION OF THE INVENTION

The present invention refers to a folding wheelchair comprising the following:
three wheels in a tricycle configuration, two rear wheels and a front wheel,
a frame located between the two rear wheels, which comprises a seat with a backrest and a footrest, and
two axes of the two rear wheels,
   so that:
the folding wheelchair comprises a single-arm chassis, located on one of the sides of said wheelchair, which connects the frame with the front wheel,
   where the three wheels are rigid, and the rear wheels comprise propelling hand rims located between the rear wheels and the seat, and a reduction mechanism located in each of the axes of the two rear wheels between the propelling hand rims and the rear wheels, in order to reduce the force that needs to be applied to said rear wheels.

The single-arm chassis provides free access to the chair from one of its sides, and it preferably has a length between 1000 and 1500 mm.

The wheelchair is made with materials resistant to the corrosive environment of beaches, preferably materials chosen among aluminium, carbon fibre, polymers reinforced with fibre glass and/or carbon fibre; the wheels (front and rear) are made with fibre-reinforced polymeric material.

Additionally, the folding wheelchair comprises rails located in the area where the frame connects with the rear wheels, which can change the position of the rear wheels relative to the seat in the horizontal axis (forwards and backwards), allowing frequent users of this type of wheelchairs to control their centre of gravity, so that the front wheel can be easily raised in order to provide better handling of the wheelchair.

The rear wheels comprise a diameter between 500 and 800 mm, preferably 700 mm, and a width between 200 and 300 mm.

The front wheel comprises a diameter between 400 and 600 mm, preferably 500 mm, and a width between 100 and 200 mm. Additionally, said front wheel is a pivot wheel, that is, it comprises a turn axis displaced from the axis of the front wheel in the vertical plane which, when the chair needs to be turned and one of the rear wheels is going slower than the other rear wheel, it allows the front wheel to turn in the direction that the wheelchair needs to be turned, while if both rear wheels are going at the same speed, the front wheel stays straight during the journey.

The folding wheelchair also comprises push handles that allow it to be pushed by another person, and folding armrests; while the rear wheels comprise brake levers to stop the wheelchair.

### BRIEF DESCRIPTION OF THE DRAWINGS

To complete the description and in order to give a better understanding of the characteristics of the invention, this descriptive report is accompanied by a series of drawings that are an integral part of the report, wherein, for illustration purposes and without limitation, the following has been represented:

FIG. 1.—Shows two profile views of the folding wheelchair when the wheelchair is completely unfolded.

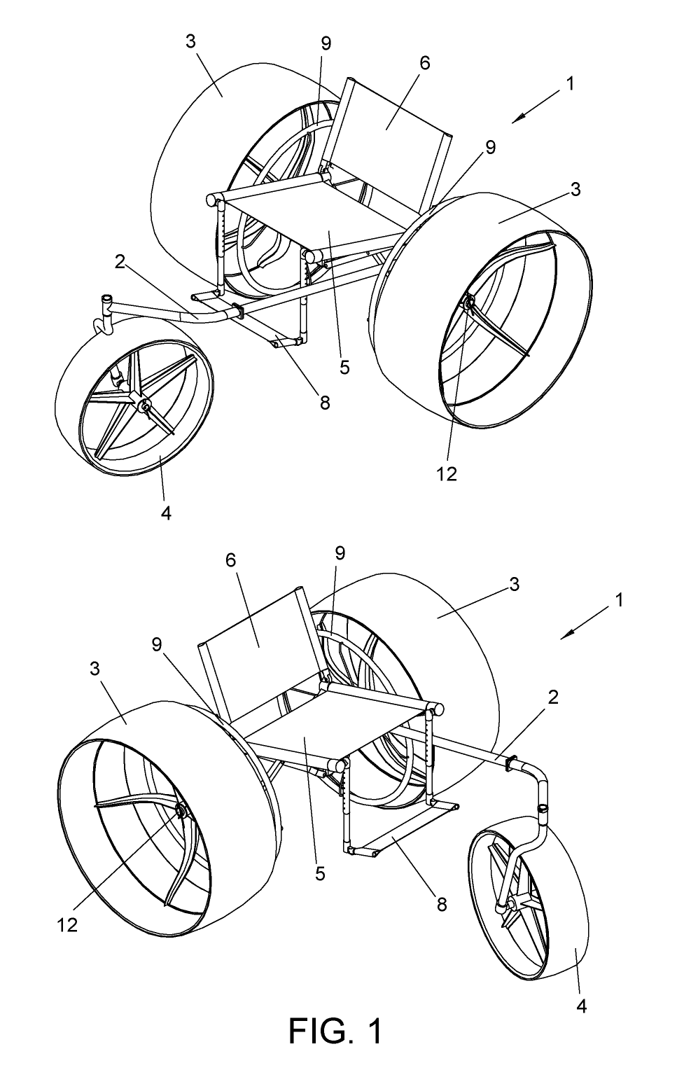

FIG. 2.—Shows two profile views of the folding wheelchair when the wheelchair is partially unfolded.

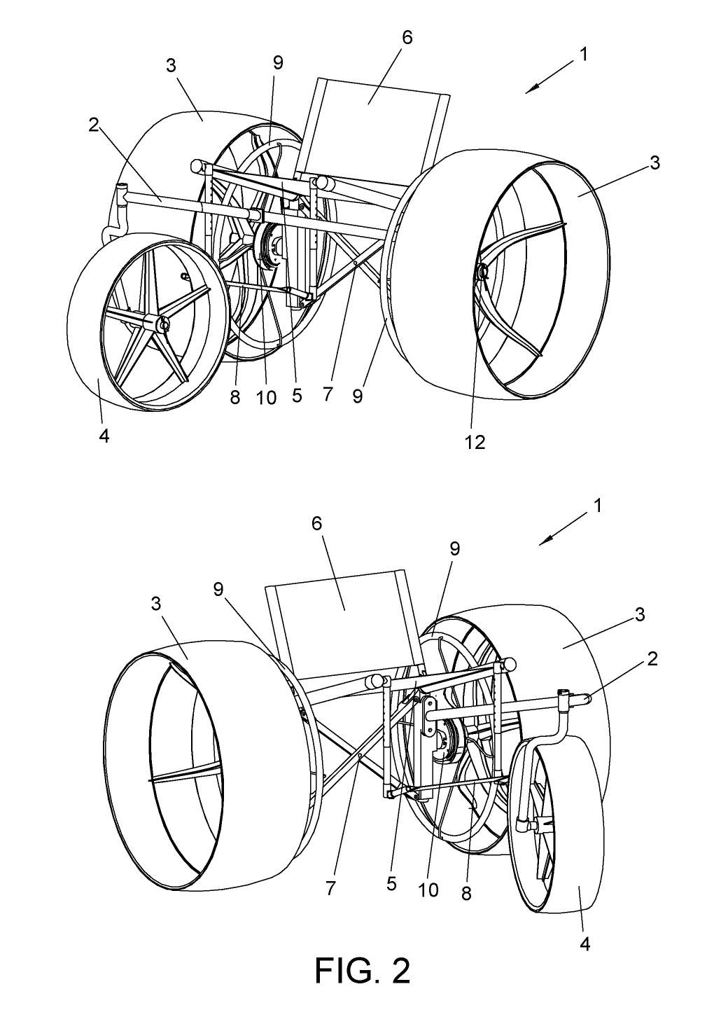

FIG. 3.—Shows two profile views of the folding wheelchair when the wheelchair is completely folded.

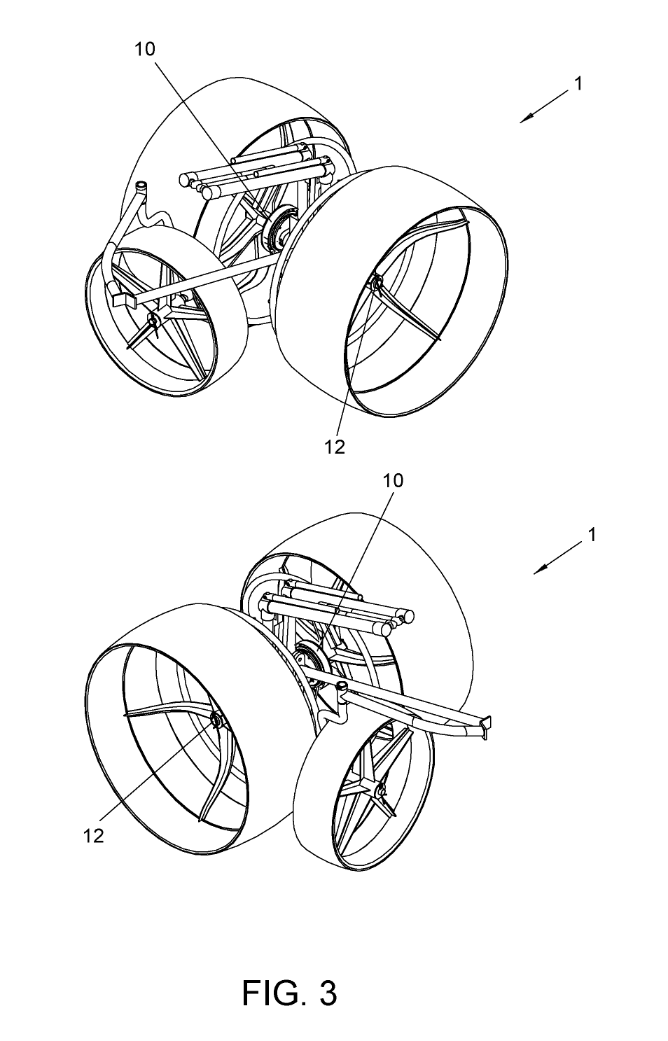

FIG. 4.—Shows an exploded view of the reduction mechanism of the rear wheels.

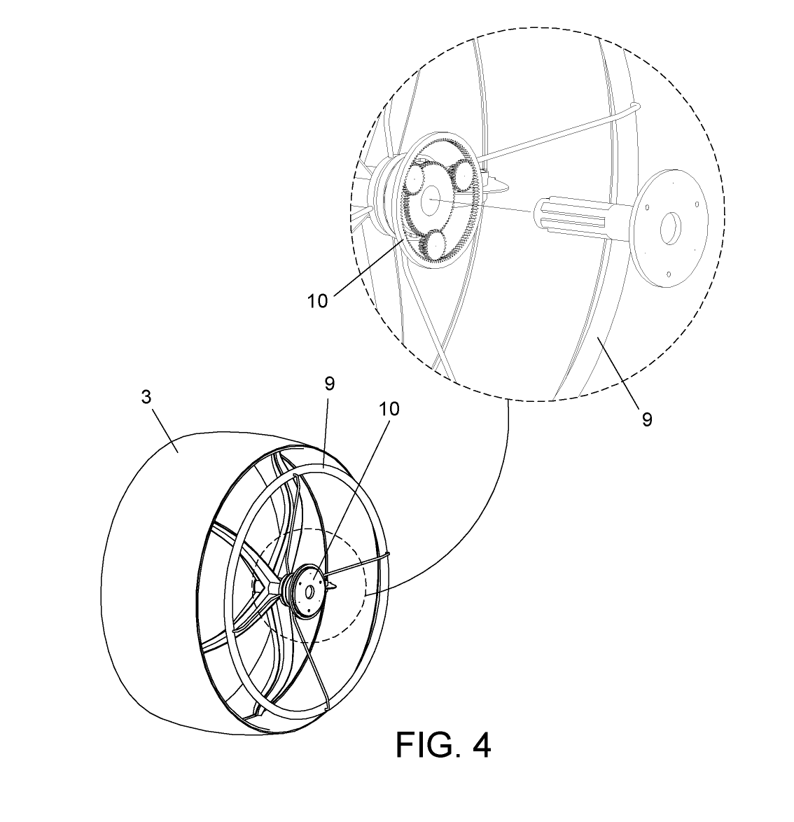

FIG. 5.—Shows a view of the rails located in the area where the frame is connected to the rear wheels.

A list of the different components that have been represented in the drawings and that comprise the invention is detailed below:

1. Wheelchair.

2. Single-arm chassis.

3. Rear wheels.

4. Front wheel.

5. Seat.

6. Backrest.

7. Frame.

8. Footrest.

9. Propelling hand rims.

10. Reduction mechanism.

11. Rails.

12. Axes of the two rear wheels.

### DETAILED DESCRIPTION

The present invention discloses a folding wheelchair (1) for disabled people, designed to be used mainly in terrains where movement is difficult, such as a sand beach.

This folding wheelchair (1) can be used independently and autonomously by a disabled person with arm mobility. Nevertheless, the folding wheelchair (1) also comprises push handles (not shown in the drawings) that allow it to be pushed by another person.

The folding wheelchair (1) which is the object of the invention comprises the following:
three rigid wheels in a tricycle configuration, two rear wheels (3) and a front wheel (4),
a frame (7) located between the two rear wheels (3), which comprises a seat (5) with a backrest (6) and a footrest (8), and
a single-arm chassis (2) located on one of the sides of the wheelchair (1), which connects the frame (7) with the front wheel (4) and provides easy access to the wheelchair (1), and
two axes (12) of the two rear wheels (3),
   where the rear wheels (3) comprise propelling hand rims (9) (hand rims used to manually propel wheelchairs) and a reduction mechanism (10) to reduce the force that needs to be applied in order to overcome the high rolling resistance of surfaces such as sand.

Both the backrest (6) and the footrest (8) are adjustable.

The rigid wheels have the advantage of having a lower rolling resistance on hard surfaces and they need less maintenance in comparison with pneumatic wheels, since the latter would need to be constantly checked for air pressure. If the wheels were the conventional type of wheel instead of rigid wheels, users would need to apply great force in order to overcome the resistance met by said wheels on sand surfaces.

Therefore, a rigid wheel is the type of wheel where the surface contact with the ground is rigid and does not have a tyre or a tube.

Said wheels (3, 4) are made with fibre-reinforced polymers, preferably rigid polymer.

The rear wheels (3) comprise a diameter between 500 and 800 mm, preferably a diameter of 700 mm, and a width between 200 and 300 mm.

The front wheel (4) comprises a diameter between 400 and 600 mm, preferably a diameter of 500 mm, and a width between 100 and 200 mm, preferably 150 mm.

Said front wheel (4) is a pivot wheel, that is, it comprises a turn axis displaced from the axis of the front wheel (4) in the vertical plane which, when the chair (1) needs to be turned and one of the rear wheels (3) is going slower than the other rear wheel (3), it allows the front wheel (4) to turn in the direction that the wheelchair (1) needs to be turned, while if both rear wheels (3) are going at the same speed, the front wheel (4) stays straight during the journey.

Due to being located on one of the sides of the wheelchair (1), the single-arm chassis (2) allows the user to make comfortable and easy transfers (such as moving from one chair to another or to the ground, the bed, etc.) since it provides free access to the chair (1) from one of its sides, and it preferably has a length between 1000 and 1500 mm.

Additionally, the single-arm chassis (2) can also include other components that make it easier to move the wheelchair (1).

The propelling hand rims (9) are located on the inner perimeter of the rear wheels (3), that is, between the rear wheels (3) and the seat (5), and not on the outside of the rear wheels (3) as is common practice. Said propelling hand rims (9) are thus placed because otherwise, due to the significant width of the rear wheels (3), users would need to spread their arms a lot in order to propel the wheelchair forward, which would be uncomfortable.

The reduction mechanism (10) can limit the force needed to be applied in conditions where the rolling surface is the most difficult, such as the case of sand. This reduction mechanism (10) allows the user to put an acceptable level of effort that is directed mostly to the forward thrust on the rear wheels (3) in order to move the wheelchair (1), although the speed attained is lower than the speed that the same thrust would attain on dry land.

Said reduction mechanism (10) is a conventional epicycloidal reduction mechanism (epicycloidal reductor) located on each of the axes (12) of the rear wheels (3), between the propelling hand rims (9) and the rear wheels (3), and it comprises a planetary with two satellites in a fixed crown configuration where both input and output are located on the same side. The planetary gear train comprises a “crown”, “sun, “satellites” and a “planet bearing arm”. The “sun” gear receives the input (which is connected to the propelling hand rim (9)) and the “planet bearing arm” transmits the output (which is connected to the rear wheel (3)). This input and output configuration turn in the same direction.

Given the characteristics of the environment where the wheelchair (1) is designed to work in (dust, sand, salt water, sunny outdoors), the wheelchair is designed with simple folding mechanisms and does not have any mechanisms prone to get stuck due to sand, salt residue, etc.

Moreover, the wheelchair (1) can be easily folded and handled so that users can carry it in a conventional vehicle, load it and unload it from the trunk of a car, as well as mount it and dismount it using only their own hands. When users are going to enter this type of terrains (sand beach . . . ), users transfer from their own conventional wheelchair to the folding wheelchair (1).

The wheelchair (1) is folded in two steps. Firstly, the frame (7) is folded by means of a “scissors” mechanism so that the rear wheels (3) get close together reducing the space that was taken by the seat (5), which ends up completely folded (lateral bars together). Secondly, the single-arm chassis (2) is folded in half, reducing its total length to the minimum possible space taken by the wheels (3, 4).

The folding wheelchair (1) is built with light and resistant materials that can withstand the corrosive environments of beaches (salt water), and it takes the smallest possible space when it is folded.

Said materials are chosen between aluminium, carbon fibre, polymers reinforced with fibre glass and/or carbon fibre.

In the preferred embodiment of the invention, the design of this wheelchair (1) allows the user to do a “wheelie” (keep the chair balanced on its two rear wheels (3)). In order to do so, the centre of gravity can be regulated along the axes (12) of the two rear wheels (3).

This is done by means of rails (11) located in the area where the frame (7) connects to the rear wheels (3), where said rails (11) can change the position of the rear wheels (3) relative to the seat (5) in the horizontal axis (forwards and backwards), allowing frequent users of this type of wheelchairs (1) to shift their centre of gravity, so that the front wheel (4) can be easily raised in order to provide better handling of the wheelchair (1). Therefore, said horizontal adjustment of the rear wheels (3) is important to shift the centre of gravity and adapt it to the conditions and skills of each user. As a consequence of shifting the centre of gravity towards the back, the front wheel (4) will only hold a small part of the weight of the user.

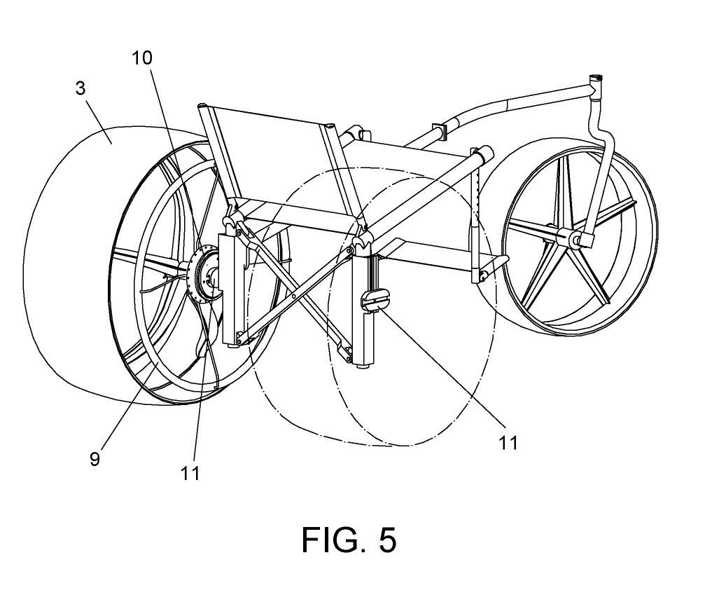

The axes (12) of the two rear wheels (3), which allow the rear wheels (3) to turn, are connected to the frame (7) by means of said rails (11). As shown on FIG. 5, each rail (11) comprises a guide where each of the axes (12) is inserted into.

In those cases where the wheelchair (1) does not include said rails (11), the axes (12) of the two rear wheels (3) would be connected directly to the frame (7).

The rear wheels (3) comprise brake levers to stop the wheelchair (not shown on the drawings).

There is also the possibility of adding folding armrests (not shown on the drawings) to improve user comfort.

The rear wheels (3) are propelling wheels in order to make it easier to climb kerbs. Additionally, the front wheel (4) does not interfere with the feet of the user or the footrest (8) when it is turning.

The present invention is not limited by the embodiment disclosed herein. Other configurations can be made by experts in the art following the present description. In consequence, the scope of the invention is defined by the following claims.

1. Folding wheelchair (1) comprising:
three wheels in a tricycle configuration, two rear wheels (3) and a front wheel (4),
a frame (7) located between the two rear wheels (3), which comprises a seat (5) with a backrest (6) and a footrest (8), and
two axes (12) of the two rear wheels (3),
it is characterized in that:
the folding wheelchair (1) comprises a single-arm chassis (2), located on one of the sides of said wheelchair (1), which connects the frame (7) with the front wheel (4),
where the three wheels are rigid, and the rear wheels (3) comprise propelling hand rims (9) located between the rear wheels (3) and the seat (5), and a reduction mechanism (10) located in each of the axes (12) of the two rear wheels (3) between the propelling hand rims (9) and the rear wheels (3), in order to reduce the force that needs to be applied to said rear wheels (3).

2. Folding wheelchair (1) according to claim 1, characterized in that it comprises rails (11), located in the area where the rear wheels (3) connect with the frame (7), in order to change the horizontal position of the rear wheels (3) in relation to the seat (5).

3. Folding wheelchair (1) according to claim 1, characterized in that the front wheel (4) comprises a turn axis displaced from the axis of the front wheel (4) in a vertical plane.

4. Folding wheelchair (1) according to claim 3, characterized in that the wheels (3, 4) are made with fibre-reinforced polymers.

5. Folding wheelchair (1) according to claim 4, characterized in that the rear wheels (3) comprise a diameter between 500 and 800 mm.

6. Folding wheelchair (1) according to claim 5, characterized in that the rear wheels (3) comprise a diameter of 700 mm.

7. Folding wheelchair (1) as claimed in claim 5, characterized in that the rear wheels (3) comprise a width between 200 and 300 mm.

8. Folding wheelchair (1) according to claim 7, characterized in that the front wheel (4) comprises a diameter between 400 and 600 mm.

9. Folding wheelchair (1) according to claim 8, characterized in that the front wheel (4) comprises a diameter of 500 mm.

10. Folding wheelchair (1) according to claim 9, characterized in that the front wheel (4) comprises a width between 100 and 200 mm.

11. Folding wheelchair (1) according to claim 10, characterized in that is built with materials that can withstand the corrosive environments of beaches.

12. Folding wheelchair (1) according to claim 11, characterized in that is built with materials chosen among aluminium, carbon fibre, polymers reinforced with fibre glass and/or carbon fibre.

13. Folding wheelchair (1) according to claim 12, characterized in that the rear wheels (3) comprise brake levers to stop the wheelchair.

14. Folding wheelchair (1) according to claim 13, characterized in that comprises push handles that allow it to be pushed by another person and folding armrests.

15. Folding wheelchair (1) according to claim 1, characterized in that the single-arm chassis (2) comprises a length between 1000 and 1500 mm.

16. Folding wheelchair (1) according to claim 2, characterized in that the front wheel (4) comprises a turn axis displaced from the axis of the front wheel (4) in a vertical plane.

17. Folding wheelchair (1) as claimed in claim 6, characterized in that the rear wheels (3) comprise a width between 200 and 300 mm.
